(19) United States
(12) Patent Application Publication
(10) Pub. No.: US 2007/0080805 A1
(43) Pub. Date: Apr. 12, 2007

(54) Point of selection merchandise display system

(76) Inventors: Lukass Robert Franklin, Barrington, IL (US); Kenneth Alan Brask, Lindenhurst, IL (US); Mari Hoashi Franklin, Barrington, IL (US); Angela Tomlinson, Grayslake, IL (US)

Correspondence Address: THE ECLIPSE GROUP, 10605 BALBOA BLVD., SUITE 300, GRANADA HILLS, CA, 91344, US

(21) Appl. No.: 11/438,093

(22) Filed: May 20, 2006

Related U.S. Application Data
(60) Provisional application No. 60/683,142, filed on May 20, 2005.
(60) Provisional application No. 60/758,662, filed on Jan. 14, 2006.
(60) Provisional application No. 60/785,580, filed on Mar. 24, 2006.

(51) Int. Cl. G08B 13/14

(52) U.S. Cl. 340/572.1

(57) ABSTRACT

A system and a method of supplying content in a point of selection merchandise display system in response to detected movement of a radio frequency identification tag attached to a consumer product.

### RELATED APPLICATIONS

This application claims priority and incorporates by reference the provisional patent application, Ser. No. 60/683,142, filed on May 20, 2005, titled “Point of Selection Merchandise Display System” by Alan Brask and Lukass R. Franklin, which is incorporated by reference herein, the provisional patent application, Ser. No. 60/758,662, filed Jan. 14, 2006, titled Point of Selection Merchandise Display System, by Alan Brask and Lukass R. Franklin, which is incorporated by reference herein, and the provisional patent application, Ser. No. 60/785,580, filed Mar. 24, 2006, titled Point of Selection Merchandise Display System, by Alan Brask and Lukass R. Franklin, which is incorporated by reference herein.

### BACKGROUND OF THE INVENTION

### Background

Often when displaying merchandise in retail or other consumer product stores, the only information available to consumers is from static signage, sales tags, or from sales associates. The approaches for displaying consumer merchandise is typically on fixtures, such as tables, racks, or shelves with informational signage placed on or nearby the fixtures. Little or no information is known about the consumer or their activities at a fixture.

Some retailers are able to collect data about purchasing habits by associating purchases with a consumer through the use of buying programs, such as the programs used in many grocery and hardware stores. Such information is useful for marketing purposes, but is of little value once the consumer is in the store. The shopping habits of the consumer are typically not monitored or recorded.

Currently, the most prevalent types of monitoring that occurs in retail stores with tags are security monitoring and inventory monitoring. Neither types of monitoring is useful when attempting to give feedback to consumers and monitor their selection habits. Some types of security monitoring and inventory monitoring use radio frequency identification (RFID) tags. Security monitoring tags are not typically associated with a product or category of product. Rather, the tag is meant to activate an alarm that signals a tagged item has passed through a monitor or left a zone. Inventory RFID tags are normally active tags that require a power source so that their radio signals may be identified when the tags are on or in packages that are packed together when passing through a detector.

In the last few years, the use of displays with video content have been placed on or about fixtures in retail stores. The video content has been digital or looped video content and is not interactive or responsive to the consumer. Touch screen displays have also been used in some retail stores to provide feedback to users, but require the user to stop shopping and interact with the display directly and is limited to being accessed by only one person.

Therefore, there is a need for an approach to providing consumers feedback responsive to their actions while they are at or near a fixture in a retail store that overcomes the limitations of known approaches.

### SUMMARY

An interactive, networked point of purchase merchandise display system that directs, sequences, and dynamically creates changes in digital video and audio content, lighting configurations, and other automatable merchandise display events, store customer service and operational strategies based upon natural consumer behaviors in handling merchandise and interactively determined consumer interest attributes as the consumer decides which items to select for purchase. The system may support the consumer's decision-making process at the point of merchandise selection while increasing the level of service by generating messaging across departments and store related parties and by tying merchandise into local causes and affinities relevant to the consumer.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram of an example of an implementation of a point of selection merchandise display system (POSMDS).

FIG. 2 is a block diagram of an example of two POSMDS of FIG. 1 networked with another POSMDS.

FIG. 3 is a block diagram of another example of a distributed POSMDS that has a common controller and multiple tables.

FIG. 4 is a block diagram of an example of the POSMDS of FIG. 1 that includes additional sensors.

FIG. 5 is a diagram of a shelve example of the POSMDS that with an integrated controller and tethers.

FIG. 6 is a flow diagram illustrating an example of a process performed by the POSMDS of FIG. 1.

### DETAILED DESCRIPTION

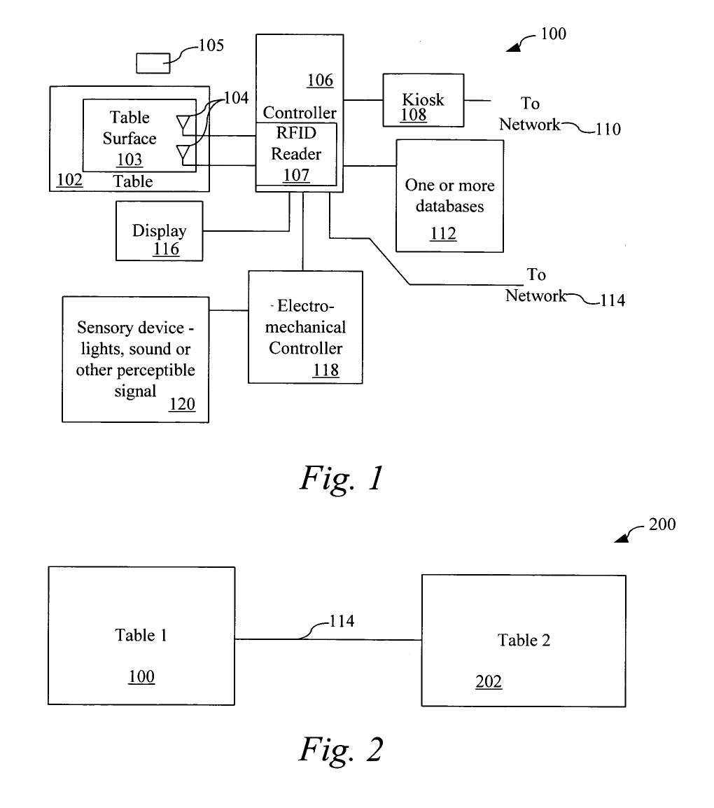

An approach for a point of selection merchandise display system (POSMDS) is disclosed that provides interactive content to consumers and supports a consumer's decision-making process at the point of selection of consumer goods. The approach is respectful of consumer privacy: the system may be physically non-invasive (no biometrics) and not dependent upon customer identification to deliver relevant content to the consumer at the moment of selection. The system is supportive of consumer metadata and for consumers opting to be identified by the system, more targeted content selection may be orchestrated at the POSMDS. Turning to FIG. 1, a block diagram of an example of an implementation of a point of selection merchandise display system (POSMDS) 100. A fixture, such as table 102 may have a surface 103 with one or more antennas located in proximity to the surface 103 of the table 102 and may be in signal communication with a controller 106 that may have an RFID reader 107. The controller 106 may be in signal communication with a kiosk 108 that may be connected to a network 110, in signal communication with one or databases 112, connected to another network 114, in signal communication with a display 116, able to receive and send commands associated with electromechanical controllers 118 that are in signal communication with sensory perceptible devices 120.

The table 102 is an example of a fixture that may be employed in a POSMDS. Other examples of fixtures for placement of products or merchandises that may be employed in the POSMDS include tabletops, raised bins, wall mounted fixtures, shelving units, racks for hanging merchandise and similar device capable of displaying consumer goods. The antennas 104 may be under, above, beside, within, or a combination of under, above, beside, and within the table 104 or other fixture. In other implementations, the surface may actually be a predefined area within a store, such as an area marked on the floor where a consumer takes a product and entry of the product into that area with an RFID tag is detectable and results in content being displayed on a display.

A radio frequency identification (RFID) tag 105 may be connected to a consumer item (product), such as an article of clothing (not shown) that is placed upon table 102. The RFID tag 105 may be an active RFID tag or a passive RFID tag. The passive RFID tags currently cost less than active RFID tags and may be simpler to deploy on a large number of consumer goods. Upon a consumer moving the item generates a signal via the RFID tag 105 that is detected at the one or more antennas 104. The signal is then received by RFID reader 107 and processed by the controller 106 that decodes the signal via accessing a database 112 of RFID tag identifiers and triggers content based upon the RFID tag identifier. The content that is triggered may be displayed upon display 116 or sent to kiosk 108. The controller may also trigger sensory devices 120 in response to the decoding the RFID tag.

The triggering of content messages based upon the controller 106 receiving information about an RFID tag may occur in response to different detected activity. The detectable activity may include absence or presence of a specific RFID tag or combination of RFID tags. A time period, time of day, and location of a RFID tag 105 may trigger content. Consumer interaction with merchandise bearing RFID tag 105 may also trigger content. Consumer interaction with a display input mechanism may trigger content as the detection of a consumer presence or absence from the display area. The controller 106 may receive messages via the network 114 from other POSMDS or other systems located with the store.

One approach to determining movement of the RFID tag 105 is based upon the change in signal strength of the RFID tag. In other approaches, more than one antenna 104 may be used and movement in the X-axis, Y-axis and Z-axis may be detected. Further, the different antennas based partially or completely on changing received signal strengths may detect rotation of the radio frequency tags and the item the tag is attached to.

Using predetermined movement patterns of active or passive RFID tags, input of predetermined commands to the controller 106 may occur. An example of this type of input would be a circular motion of a unique RFID tag detectable at antennas 104 causes the controller 106 to conduct a self-test. More general input may be accomplished by allowing any tag that makes a circle to trigger a self-test. The circular motion triggering a self-test example is only used to illustrate that not only data contained in the RFID tag can trigger the controller 106 to take action, but also the nature of the movement (direction or speed) of the tag itself may trigger the controller 106 and/or preprogrammed actions associated with the controller 106.

The content messages may be digitized images located in a storage device coupled to the controller 106, such as a RAM drive, hard disk drive, or light readable media (for example compact disk or digital video disk). But in other implementations, the content may be retrieved from videotape or other pictorial storage, such as film. The controller 106 may access the content over the network 114. The network may be a wide area network or a local area network such as the Internet or a private network, as long as content can be distributed over the network in response to the controller. The network 110 and 114 may be a wired network, wireless network or a combination of wired and wireless network. The POSMDS 100 may receive content and predetermined display and messaging definitions and other configuration data over network 110 or 114 as well as being remotely managed from an offsite location.

The display 116 may be a LCD display, CRT display, video projector, LED sign, machine selectable signage (traditional signage displayable by use of motors or relays). The POSMDS may have one or more displays and they may be a two-sided LCD displays. Similar to the display 116 is a display in kiosk 108. The display in kiosk 108 may be a touch screen to provide consumers with an additional method of interacting with the POSMDS. The kiosk 108 may also have additional input and output devices, such as motion detectors, barcode scanners, printers, mouse, keyboard, audio input, and audio output. The Kiosk 108 may have its own controller and be network to a network 110 in order to send and receive additional consumer information. In other implementations, the controller 106 may reside in the Kiosk 108. The networks 110 and 114 may be the same network or separate networks.

The POSMDS 100 may also be capable of learning and teaching merchandisers about consumer behavior patterns, and the relationship between the content message and the decision to select consumer goods for purchase. Types of merchandise movements can be tracked, stored and correlated to merchandising/sales content messaging as well as to actual consumer selection. The determination of a sale may be made by the POSMDS 100 determining a consumer good has left the table and not returned or via the network 114 that may be in signal communication with a merchandisers' sales system. The POSMDS 100 may also dynamically adjust its sales content messaging based upon the most successful messages at that specific location and unique circumstances using data stored in a database 112 and processed by controller 106. The POSMDS 100 may be able to track the most effective merchandising layouts that encourage consumer handling of the merchandise for selection, and provide data for merchandise managers to determine the most effective merchandise layouts.

The POSMDS 100 may be capable of communicating with other systems via network 114. Examples of other systems include security systems for movements correlated with shoplifting and theft; salesperson or service person alert for movements correlated with a consumer needing help with the decision process; point of sales system for commissioning the sales person who assisted the customer in selecting merchandise for purchase; promotional systems for special sales that apply to the merchandise being considered for purchase; inventory systems for the need to restock; other display areas for directing the consumer to where merchandise of their preferred size, shape, color are located in the store; community information system to tie local cause marketing with merchandise or community calls to action; alert systems like the amber alert system that are used in many of the states.

In other implementations, the relationship between antennas, controllers, display screens and external systems may be many-to-many. For example, a smart “wall” having multiple antennas, each connected to a controller able to decode RFID signals and in signal communication with multiple displays, in turn is connected to a managing controller (such as a personal computer) enabling content messages to travel down the wall with a consumer in possession of an item having a RFID tag walking beside the wall.

In FIG. 2 a block diagram 200 of an example of the POSMDS 100 of FIG. 1 networked with another POSMDS 202. The POSMDS 100 is able to communicate with POSMDS 200 via network 114. Content may be shared between the two POSMDS systems enabling more data to be accessed by the networked POSMDSs 100, 200 than either POSMDS could access individually. The POSMDSs 100 and 200 may be networked together with a wired network connection 114 or a wireless network connection. The network connection may be isolated to only POSMDSs or be coupled to an external network, such as the Internet.

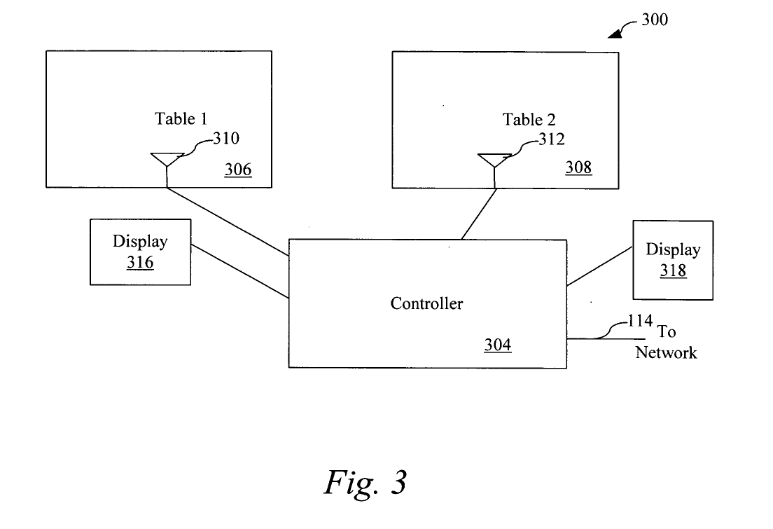

Turning to FIG. 3, a block diagram 100 of an example of a distributed POSMDS 302 that has a common controller 304 and multiple tables 306, 308 and displays 316, 318 is shown. Each table 306 and 308 has one or more associated antennas 310 and 312 respectively. The controller may also be coupled to a network 114. The controller 304 is able to access remote database via network 114 and respond with content to either display 316 and 318. By using a many table to one controller configuration of POSMDS 302, a savings may be achieved in the deployment of POSMDSs.

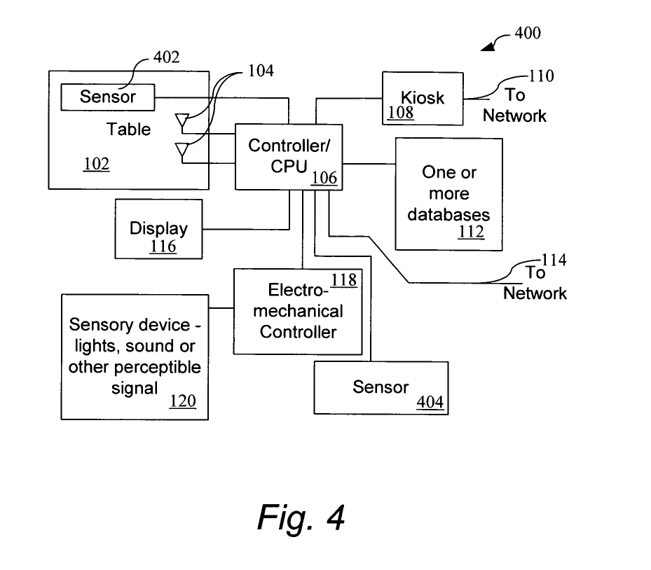

In FIG. 4 a block diagram 400 of an example of the POSMDS 100 of FIG. 1 that includes additional sensors 402 and 404 is shown. One or more antennas 104 and one or more sensors 402 and 404, such as motion detectors, may monitor a merchandise fixture, such as a table. The output data of the one or more antennas 104 detecting movement of an RFID tag 105 encoded with a unique tag identifier that may be attached to products and one or more sensors, such as 402 and 404, may be processed by a controller 106 and based upon the received data triggers the display 116, electro-mechanical controller 118 that then controls a sensory perceptible device 120, such as lights, sound or other perceptible signals. Examples of sensors that may be used include motion, infrared, sound, sonic, liquid, odor, pressure, retinal, iris, weight, temperature, laser, light, radar, voice recognition, velocity, humidity, radio, ultraviolet, electromagnetic, magnetism, to name but a few types of sensors.

The content for the display 116 and RFID tag data may be contained in one or more databases 112 that may be accessed by the controller 106. Furthermore, sensor 404 may be placed around the merchandise fixture that relay information back to the controller 106. The sensor 404 may be in places of the sensors 402 located on the merchandise fixture or in addition to the merchandise fixture.

In other implementations, locations around the fixture may be identified for customers to stand in or move through that trigger sensors or aid in a sensor gathering data. Examples of such spots may include weight sensors that determine a customers weight while standing on the spot. The weight data is then combined with data from a motion sensor on the merchandise table, height sensor, and data from a RFID tag attached to a product that is handled by the customer to trigger content on a display such as risk for heart attack when looking at vitamins for reducing high blood pressure.

In yet other implementations, multiple merchandise tables may be connected together and sensor data may be shared or transferred between them resulting in content changing at one or more merchandise tables as a customer moves within the store or from table to table. Further, the merchandise table may be networked into other networks, such as a checkout system and/or inventory system.

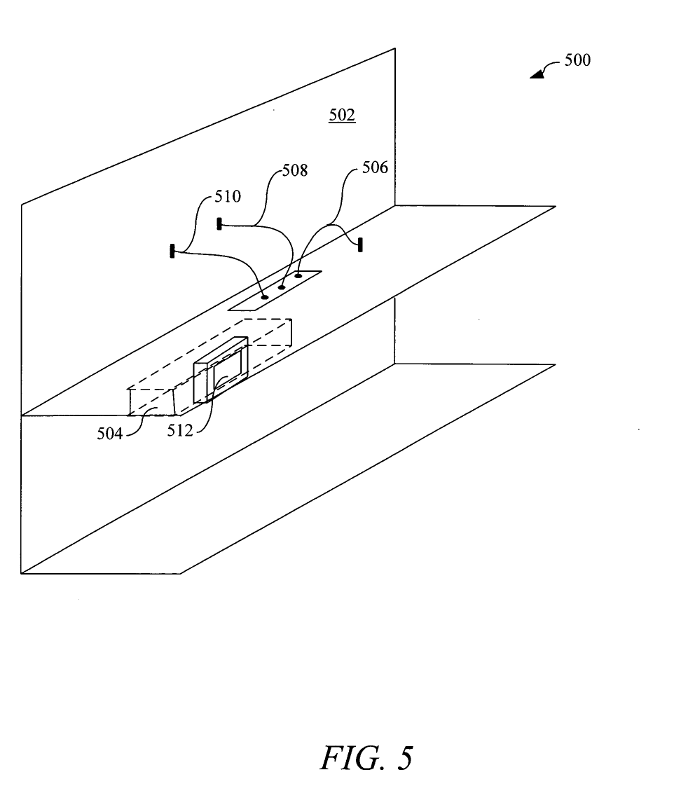

Turning to FIG. 5 a diagram 500 of a shelve 502 example of the POSMDS with an integrated controller 504 and tethers 506, 508 and 510. The integrated controller 504, may be a personal computer, and have a display such as a touch screen LCD 512. The controller 504 may also be coupled to a RFID reader (not shown) to enable decoding of RFID signals. The shelving unit 502 is the type of fixture (bracketed shelf for example) commonly found in stores for displaying merchandise. The shelving unit 502 may have a security cable or tether system that enables cables or tethers 506-510 to be secured to the shelf and a product. The tethers 506-510 may be connected to alarms that sound when cut and may also contain wires that attached to an RFID tag. Cut tethers may cause a human perceptible alarm to go off or a silent alarm to occur that is registered in a remote location within a store or building or at another location outside of the store. Or the RFID tags may be attached to the outside or built into the tethers 506-510. One or more of the cables, shelves, or shelving units may act alone or in combination as an antenna (depending on the implementation) for the RFID reader contained in controller 504.

Touching merchandise on the table may trigger consumer content on the display or trigger other human perceptible event, such as alarms, lights, sounds, smells based upon a detectable change in capacitance. Similarly, moving the RFID tag may trigger consumer content on the display 512 or trigger other human perceptible event, such as alarms, lights, sounds, smells, to name but a few. The tethers 506-510 may be permanently connected at the table end or the other end. In some implementations, the tethers 506-510 will be detachable from the table, like removing a plug from a socket.

Packaged merchandise may have at least two capacitive plates that react to pressure and touch. Further, a RFID tag may also be present along or in combination with the conductive plates on or in the packaged merchandise. Metal objects may be packaged or displayed in such a way to cause content to be triggered on the display 512 when a resistive value of the metal object is changed.

In FIG. 5, the POSMDS 500 may also be battery powered with batteries such as deep cell wet batteries, gel cell batteries, dry chemical batteries. The battery power would enable operation of the RFID reader and controller 504, display 512 and network connections in some implementations when power is unavailable. A power saving circuit may also be used with the batteries in order prevent the batteries from being fully discharged. An external on/off switch would also be use to disconnect the batteries from the reset of the consumer display. A solar panel, generator, AC current with an inverter, alternator or similar device may be used to recharge the batteries to a full charge upon the batteries being at least partially discharged. In another implementations, the batteries may be used as a backup power supply to keep the consumer display functioning during a power loss.

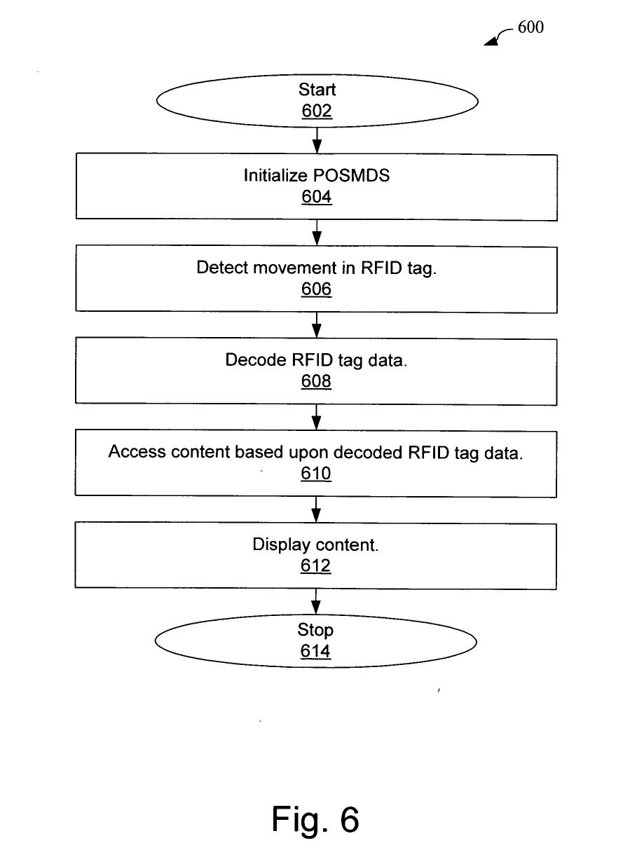

Turning to FIG. 6 a flow diagram 600 illustrating an example of a process performed by the POSMDS 100 of FIG. 1 is shown. The process starts 602 with the POSMDS 100 being powered up and initialized in step 604. Once initialized, the POSMDS 100 waits to detect the movement of a RFID tag in step 606. Once movement of the RFID tag is detected in step 606, the signal is sent to the controller 106 via antennas 104 and is decoded in step 608. In step 610, content is accessed based upon the RFID tag data decoded in step 608. The content is then displayed in step 612 and processing is complete in step 614. In practice, the processing would start again at step 606.

It is appreciated by those skilled in the art that the flow diagram shown in the graphical user interfaces of FIGS. 6 may selectively be implemented in hardware, software, or a combination of hardware and software. An embodiment of the process steps may employ at least one machine-readable signal bearing medium. Examples of machine-readable signal bearing mediums include computer-readable mediums such as a magnetic storage medium (i.e., floppy disks, or optical storage such as compact disk (“CD”) or digital video disk (“DVD”)), a biological storage medium, or an atomic storage medium, a discrete logic circuit(s) having logic gates for implementing logic functions upon data signals, an application specific integrated circuit having appropriate logic gates, a programmable gate array(s) (“PGA”), a field programmable gate array (“FPGA”), a random access memory device (“RAM”), read only memory device (“ROM”), electronic programmable random access memory (“EPROM”), or equivalent. Note that the computer-readable medium could even be paper or another suitable medium, upon which the computer instruction is printed, as the program can be electronically captured, via, for instance, optical scanning of the paper or other medium, then compiled, interpreted or otherwise processed in a suitable manner if necessary, and then stored in a computer memory.

Additionally, machine-readable signal bearing mediums include computer-readable signal bearing mediums. Computer-readable signal bearing mediums have a modulated carrier signal transmitted over one or more wire based, wireless or fiber optic networks or within a system. For example, one or more wire based, wireless or fiber optic networks, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor or controller, such as a microprocessor, digital signal processor, discrete logic circuit functioning as a controller, or other system that can fetch the instructions from the instruction execution system, apparatus, or device and execute the instructions.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed is:

1. A point of selection merchandise display system, comprising:
a surface for placement of products where at least one of the products is associated with a radio frequency identification (RFID) tag;
an at least one antenna associated with the surface capable of receipt of RFID signals that contain a tag identifier from the RFID tag;
a display; and
a controller in signal communication with the at least one antenna and is in receipt of the tag identifier that results in access of content associated with the tag identifier and transmission of the content to the display which is in signal communication with the controller.

2. The point of selection merchandise display system of claim 1, where the content is digitized images.

3. The point of selection merchandise display system of claim 1, includes a network connection over which the content is accessed.

4. The point of selection merchandise display system of claim 1, includes at least one database accessible by the controller data associated with the tag identifier.

5. The point of selection merchandise display system of claim 1, includes an electro-mechanical controller in signal communication with the controller and responsive to the tag identifier.

6. The point of selection merchandise display system of claim 5, further includes a sensory perceptible device that is in signal communication with the electro-mechanical controller and responsive to the electromechanical controller in response to the tag identifier being receipt at the controller.

7. The point of selection merchandise display system of claim 1, includes a kiosk in signal communication with the controller and responsive to the tag identifier.

8. The point of selection merchandise display system of claim 1, where the controller stores data associated with movement of the RFID tag in a database.

9. The point of selection merchandise display system of claim 1, where the display is a multisided display.

10. The point of selection merchandise display system of claim 8, further includes at least two antennas used to determine the movement of the RFID tag in a plane.

11. The point of selection merchandise display system of claim 1, where the surface is a predefined area associated with the at least one antenna.

12. The point of selection merchandise display system of claim 1, where the predefined area is associated with a rack from which products hang.

13. A point of selection content delivery method, comprising the steps of:
selecting a product located on a surface where the product is associated with an radio frequency identification (RFID) tag;
receiving at an at least one antenna associated with the surface a RFID signal that contain a tag identifier from the RFID tag;
selecting content in response to the tag identifier at a controller in signal communication with the at least one antenna; and
displaying on a display the content selected by the controller.

14. The point of selection content delivery method of claim 13, where the step of selecting further includes the step of accessing stored digitized images.

15. The point of selection content delivery method of claim 13, where the step of selecting further includes retrieving content via a network connection.

16. The point of selection content delivery method of claim 13, includes the step of accessing at least one database by the controller with the tag identifier.

17. The point of selection content delivery method of claim 13, includes the step of signaling to an electro-mechanical controller that is in signal communication with the controller in response to the controller being in receipt of one or more associated tag identifier received via the at least one antenna.

18. The point of selection content delivery method of claim 17, further includes the step of activating a sensory perceptible device that is in signal communication with the electromechanical controller in response to the signaling from the controller.

19. The point of selection content delivery method of claim 13, includes the step of communicating with a kiosk that is in signal communication with the controller in response to the controller being in receipt of the tag identifier.

20. The point of selection content delivery method of claim 13, where the step of selecting content further includes the step of storing data associated with movement of the RFID tag in a database.

21. The point of selection content delivery method of claim 20, where the step of storing further includes the step of determining at an at least two antennas the movement of the RFID tag in a plane.

22. The point of selection content delivery method of claim 13, where the step of selecting a product located on a surface further includes a product being moved within a predefined area where the surface is defined by the predefined area.

23. The point of selection content delivery method of claim 22, where the predefined area is located on a floor.
